(19) United States
(12) Patent Application Publication
(10) Pub. No.: US 2013/0293119 A1
(43) Pub. Date: Nov. 7, 2013

(54) UNIVERSAL BALLAST

(71) Applicants: Scott Averitt, Roseville, MI (US); Paul Wickett, Northville, MI (US)

(72) Inventors: Scott Averitt, Roseville, MI (US); Paul Wickett, Northville, MI (US)

(73) Assignee: ROBERT BOSCH GMBH, Stuttgart (DE)

(21) Appl. No.: 13/464,371

(22) Filed: May 4, 2012

(51) Int. Cl. H05B 41/36

(52) U.S. Cl. 315/158; 315/219

(57) ABSTRACT

A universal ballast. The ballast includes a power converter, a transformer, a current sensor, and a controller. The power converter is configured to receive an input signal and convert the input signal to a direct current (DC) voltage having a first magnitude. The transformer has a center-tapped primary winding coupled to the power converter and a secondary winding coupled to a lamp. The current sensor is configured to sense a current in the secondary winding. And the controller is configured to receive an indication of the detected current from the current sensor and to determine correct operating parameters for the lamp.

### RELATED APPLICATIONS

This application is related to the following U.S. patent applications which are filed on even date herewith and which are incorporated herein by reference: U.S. application Ser. No. ______ entitled LUMINENCE CONTROL OF GAS-DISCHARGE LAMPS; U.S. application Ser. No. ______ entitled BALLAST INCLUDING A HEATER CIRCUIT; and U.S. application Ser. No. ______ entitled BALLAST WITH MONITORING.

### BACKGROUND

The invention relates to ballasts, specifically universal ballasts for operating multiple varieties of gas-discharge lamps.

Ballasts control the starting and operating of gas-discharge (e.g., fluorescent or induction) lamps. Gas-discharge lamps have a decreasing resistance characteristic in which the lamp current is not self limiting. The ballast acts to limit the current and prevent excessive current from damaging the lamp or the lamp driver.

### SUMMARY

In one embodiment, the invention provides a universal ballast. The ballast includes a power converter, a transformer, a current sensor, and a controller. The power converter is configured to receive an input signal and convert the input signal to a direct current (DC) voltage having a first magnitude. The transformer has a center-tapped primary winding coupled to the power converter and a secondary winding coupled to a lamp. The current sensor is configured to sense a current in the secondary winding. And the controller is configured to receive an indication of the detected current from the current sensor and to determine correct operating parameters for the lamp.

In another embodiment the invention provides a gas-discharge light fixture. The fixture includes a gas-discharge lamp, and a ballast. The ballast includes a power converter configured to receive an input signal and convert the input signal to a direct current (DC) voltage having a first magnitude, a transformer having a center-tapped primary winding coupled to the power converter and a secondary winding coupled to a lamp, a current sensor configured to sense a current in the secondary winding, and a controller configured to receive an indication of the detected current from the current sensor and to determine optimum operating conditions for the lamp.

Other aspects of the invention will become apparent by consideration of the detailed description and accompanying drawings.

### BRIEF DESCRIPTION OF THE DRAWINGS

FIG. 1 is a block diagram of an embodiment of a universal ballast.

FIG. 2 is a block diagram of a first embodiment of a power converter.

FIG. 3 is a block diagram of a second embodiment of a power converter.

FIG. 4 is a block diagram of a third embodiment of a power converter.

FIG. 5 is a block diagram of an embodiment of a lamp driver.

FIG. 6A is a block diagram of a first embodiment of a heater circuit.

FIG. 6B is a block diagram of a second embodiment of a heater circuit.

FIG. 7 is a schematic diagram of an embodiment of a universal ballast.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

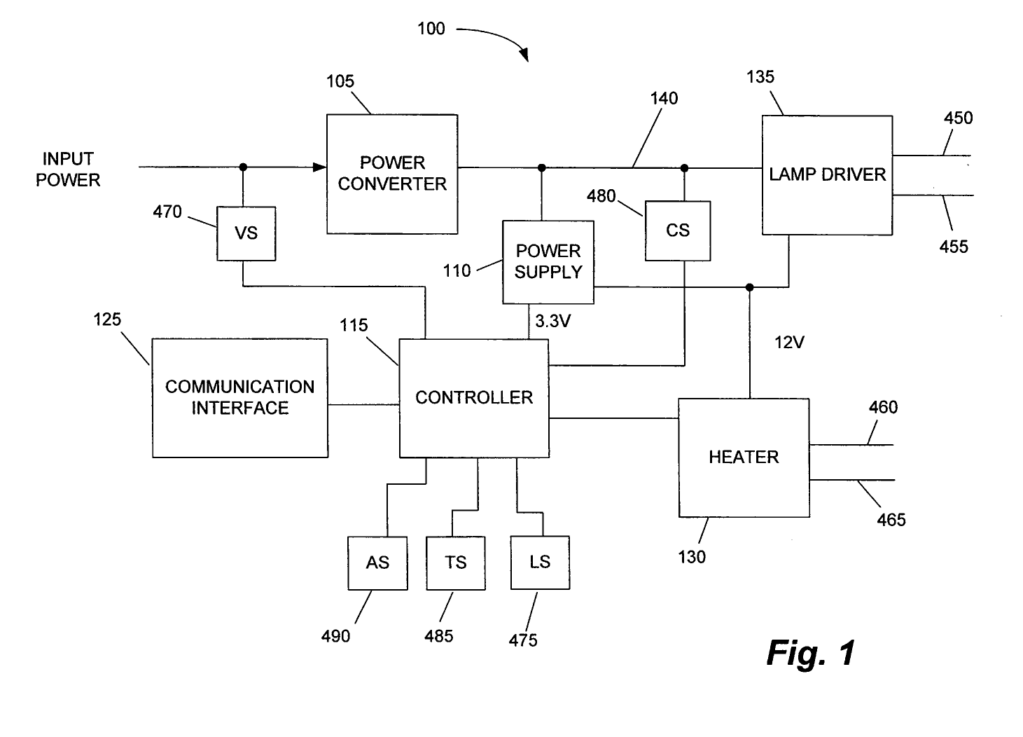

FIG. 1 shows a block diagram of an embodiment of a universal ballast 100 for gas-discharge lamps. The ballast 100 includes an input power converter 105, a power supply 110, a controller 115, a communication interface 125 (e.g., a wireless Zigbee interface), a heater circuit 130, and a lamp driver 135.

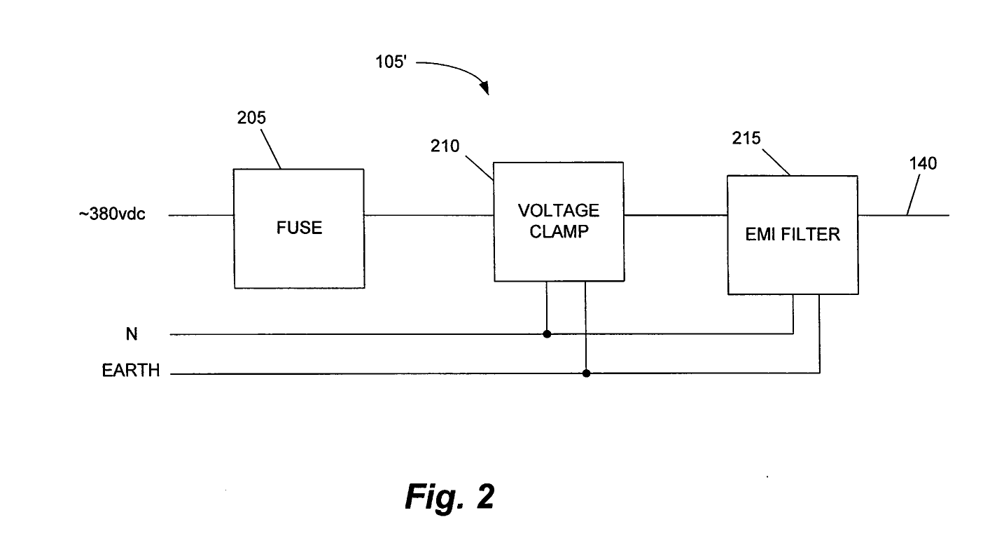

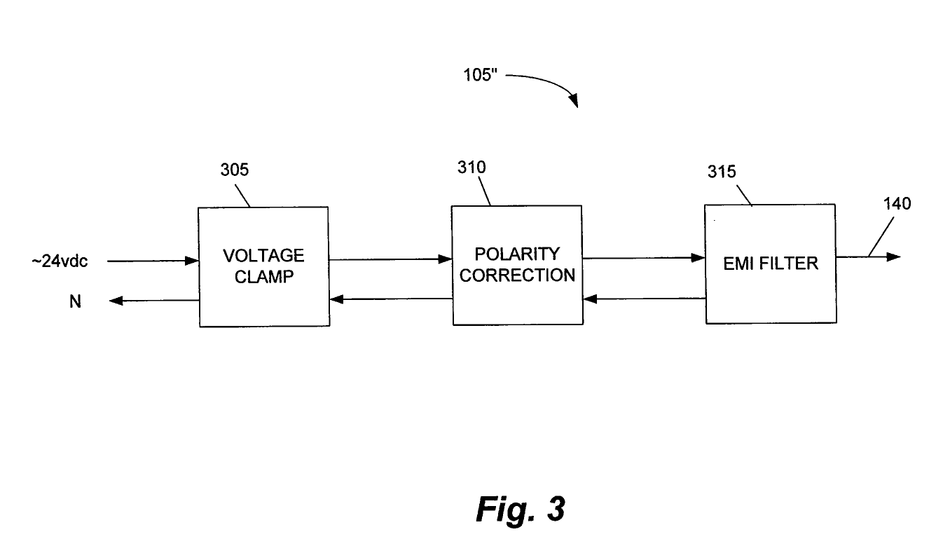

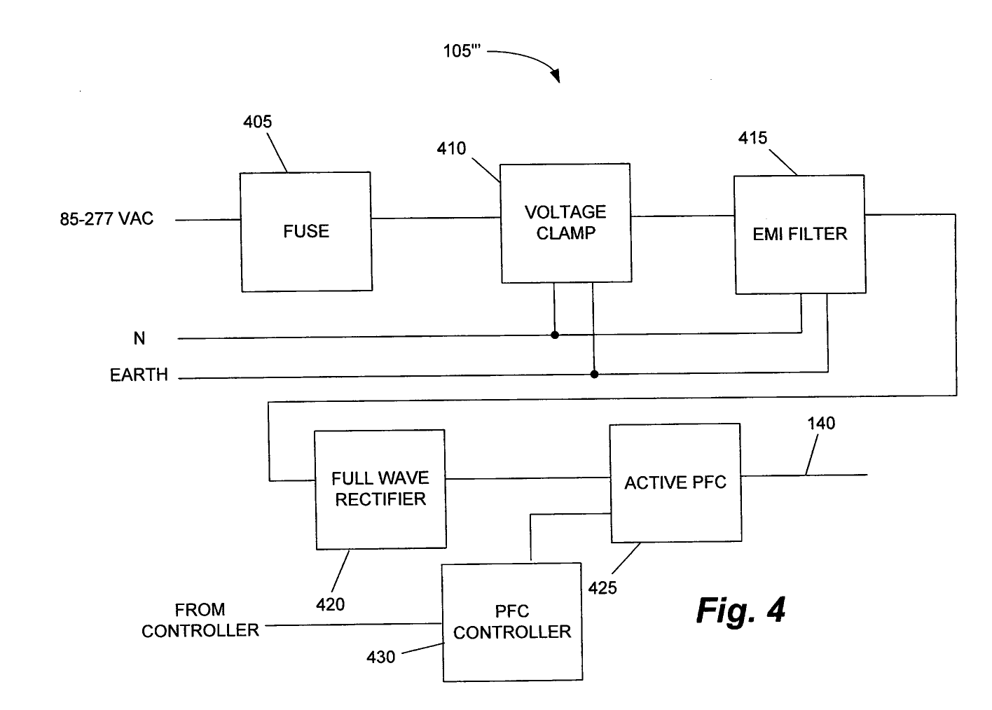

The power converter 105 converts an input signal to a DC bus power and outputs the DC bus power on line 140. FIG. 2 shows a block diagram of a power converter 105′ for converting a high-voltage DC power (e.g., 380 VDC) to the DC bus power 140 (e.g., a relatively high voltage such as 380 VDC). The converter 105′ includes a fuse 205, a voltage clamp 210, and an EMI filter 215. FIG. 3 shows a block diagram of a power converter 105″ for converting a low-voltage DC power (e.g., a relatively low voltage such as 24 VDC) to the DC bus power 140 (e.g., a relatively high voltage such as 300 VDC). The converter 105″ includes a voltage clamp 305, a polarity corrector 310, and an EMI filter 315. FIG. 4 shows a block diagram of a power converter 105′″ for converting an AC power (e.g., about 85-305 VAC) to the DC bus power 140 (e.g., a relatively high voltage such as 400 to 450 VDC). The converter 105′″ includes a fuse 405, a voltage clamp 410, an EMI filter 415, a full-wave rectifier 420, an active power factor correction (PFC) circuit 425, and a PFC controller 430. The ballast controller 115 controls the PFC controller 430.

The DC bus power 140 is provided to the lamp driver 135 and the power supply 110. The power supply 110 converts the DC bus power 140 to one or more lower voltage DC levels to power the other circuits of the ballast 100. For example, in the embodiment shown, the power supply 110 generates 12 VDC for powering components of the lamp driver 135 and the heater circuit 130. The power supply 110 also generates 3.3 VDC for powering the controller 115.

The lamp driver 135 is controlled by the controller 115 and drives a gas-discharge lamp using the DC bus power 140. The lamp driver 135 includes a lamp output 450 and a lamp return 455. Different embodiments of the ballast 100 generate different AC power for driving different gas-discharge lamps. For example, in one embodiment, the lamp driver 135 produces about 200 to about 350 VAC RMS at 100 kHz to power a fluorescent lamp. In another embodiment, the lamp driver 135 produces about 200 to about 350 VAC RMS at 250 kHz to power an inductive lamp. In the embodiment shown, the controller 115 provides a digital signal to drive the lamp driver 135. The digital signal has a frequency corresponding to the frequency of the signal produced by the lamp driver 135 (e.g., 100 kHz for a fluorescent lamp and 250 kHz for an inductive lamp).

The heater circuit 130 includes one or more heater outputs 460 and one or more corresponding heater returns 465. For fluorescent lamp embodiments, the heater outputs 460 and heater returns 465 are coupled to electrodes of the fluorescent lamp. In some embodiments, there are three electrodes and they are each driven (during a heating period) with about 4 to about 18 VAC RMS at about 1 watt each. For induction lamp embodiments, a single heater output 460 and heater return 465 are coupled to an amalgam heater of the induction lamp. In some embodiments, the amalgam heater is driven (during a heating period) with about 12 VDC at about 1 watt.

The controller 115 includes a processor (e.g., a microprocessor, microcontroller, ASIC, DSP, etc.), computer readable media or memory (e.g., flash, ROM, RAM, EEPROM, etc.), which can be internal to the processor, external to the processor, or a combination thereof, and input/output circuitry.

In some embodiments of the ballast 100, one or more sensors are used. The one or more sensors can include an input voltage sensor 470, an ambient light sensor 475, a current sensor 480, a temperature sensor 485, and an audio sensor 490. The controller 115 receives indications of the parameters measured by each sensor and uses this information to determine how to operate the lamp driver 135 to optimally power the lamp.

In some embodiments, the controller 115 determines the type of bulb being used by monitoring the current sensor 480, and adjusts the operation of the ballast 100 to accommodate the operating parameters of the bulb. Thus, a single ballast 100 is capable of driving most or all available lamps (e.g., T5, T8, compact fluorescent, etc.), each of which have different operating parameters.

The controller 115 receives an indication of ambient light in the area where the ballast 100 and lamp are installed from the ambient light sensor 475. In some embodiments, a light tube is used to direct the ambient light to the sensor 475.

For example, the audio sensor 490 can detect the presence of people in the space being lit. The controller 115 can increase the brightness of the lamp when the space is occupied and reduce the brightness when the space is empty, extending the life of the bulb and reducing the amount of energy consumed by the lamp. In some embodiments, the audio sensor 490 is used to receive voice commands (e.g., a dimming command).

Commands can be received via the communication interface 125. Commands can include turning on/off, dimming, time schedules, etc. In addition, global commands can be issued to all lamps in a building. For example, to turn off some lamps during a power outage while dimming others used for emergency lighting (i.e., lights provided with a backup power system). A combination of controls can be used such as an analog dimmer switch along with commands received via the communication interface 125.

The ballast 100 can be provided with a unique address for communications. Thus, wireless commands can be independently sent to specific lamps in a building containing large numbers of lamps.

In some embodiments, the ballast 100 controls the lamp to communicate messages by the light of the lamp. For example, the controller 115 can cause the lamp to flash in a pattern to indicate an error or alarm condition (e.g., a fire warning received via the communication interface 125). In more sophisticated schemes, the lamp can be flashed to communicate messages using Morse code. Induction lamps are capable of being flashed to send coded (e.g., digital) messages.

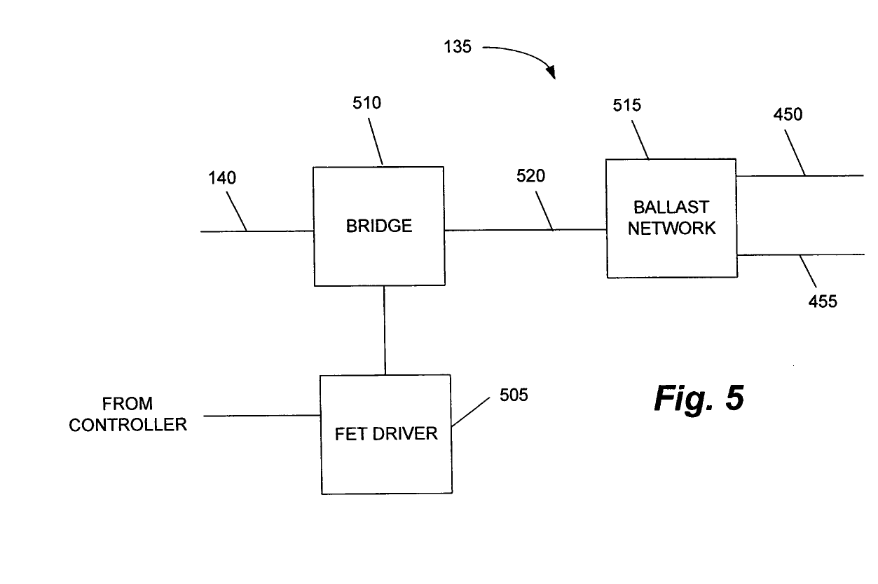

FIG. 5 shows a block diagram of an embodiment of the lamp driver 135. The lamp driver 135 includes a FET driver 505, a half-bridge 510 (or alternatively a full-bridge), and a ballast network 515. The FET driver 505 is controlled by the controller 115 to switch the half-bridge 510 such that the half-bridge 510 produces a squarewave output 520 from the DC power bus 140. The squarewave output 520 is provided to the ballast network 515 which in turn provides and AC output 450 to the lamp.

Fluorescent lamps must be “heated” before “striking” to prolong the life of the lamp as well as to improve their startup at cold temperatures. Prior-art ballasts heated the lamps by adjusting a starting frequency. The starting frequency causes the lamp electrode to heat up. After the lamp was lit, the frequency was adjusted to minimize thermal losses. The universal ballast 100 uses the separate heater circuit 130 to heat the lamp independently of the transformer 740 or the bridge 510 by supplying a current to the lamp electrodes directly. Once the lamp is lit, the heater circuit 130 is turned off completely. The result is long lamp life typical of a “programmed start” ballast and the high efficiency typical of an “instant start” ballast. In addition, the heater circuit 130 enables dimming of fluorescent lamps. In some embodiments, the heater circuit 130 is also used to heat the lamp's electrode when using the lamp in a dimming mode.

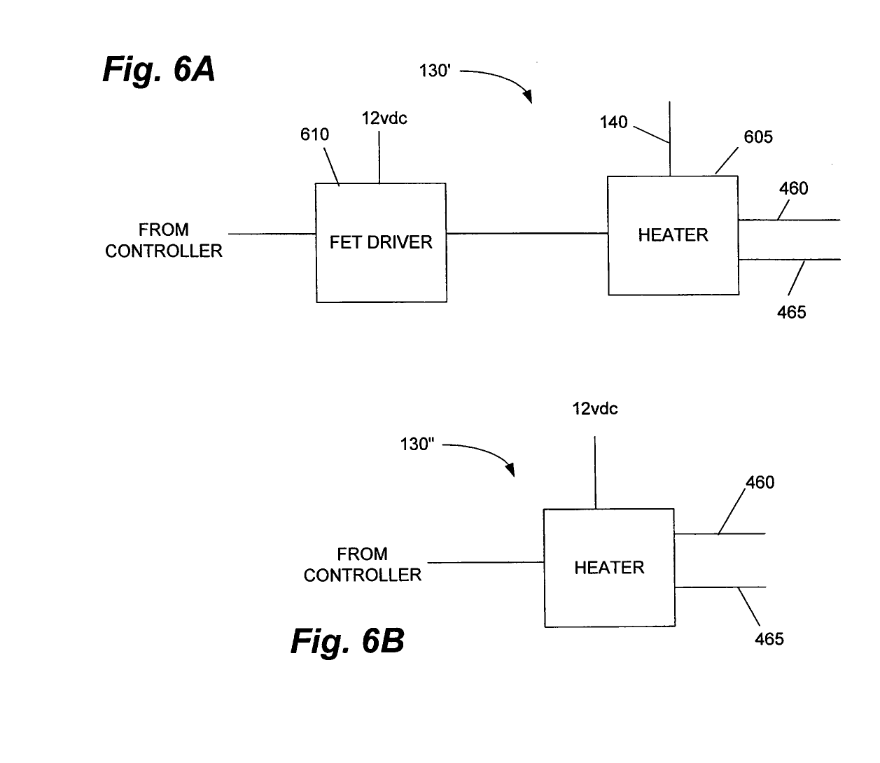

FIG. 6A shows a block diagram of an embodiment of a heater circuit 130′ for use with a fluorescent lamp. The heater circuit 130′ includes a heater 605 and a FET driver 610. The FET driver 610 is controlled by the controller 115 to drive the heater 605. The heater 605 is coupled to the DC power bus 140, and produces about 4 to about 18 VAC RMS to power each of the electrodes of the fluorescent lamp.

FIG. 6B shows a block diagram of an embodiment of a heater circuit 130″ for use with an induction lamp. The heater circuit 130″ is controlled by the controller 115, and is coupled to the 12 VDC output of the power supply 110. The heater circuit 130″ powers an amalgam heater of the induction lamp with 12 VDC.

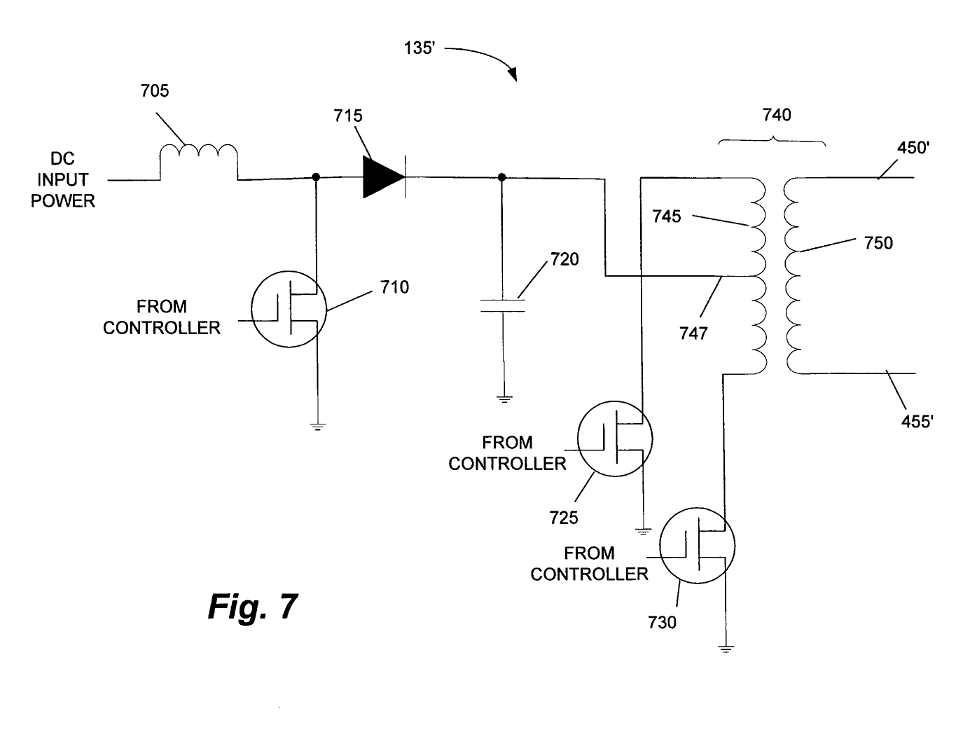

FIG. 7 shows a schematic diagram of a lamp driver 135′. The lamp driver 135′ includes a coil 705, a first switch 710, a diode 715, a capacitor 720, a second switch 725, a third switch 730, and a transformer 740 with a center-tapped primary winding 745 (with a center tap 747), and a secondary winding 750. In the embodiment shown, the first, second, and third switches 710, 720, and 725 are FETs. The transformer has a 1:1 ratio of the primary winding 745 to the secondary winding 750. In the circuit shown, DC power is applied to the coil 705 and the first switch 710 is controlled such that the coil 705, the diode 715, and the capacitor 720 generate a DC power bus voltage 140 of about 300 VDC. The controller 115 then switches the second and third switches 730 and 725 such that an AC current is generated in the secondary winding 750 of the transformer 740. The AC current powers the lamp.

Generating a DC power bus voltage 140 of 300 VDC, by boosting lower input voltages, results in current of approximately 10 times lower through the transformer 740 and the switches 730 and 725 then compared to the prior art ballasts that supply the low voltage DC directly to the transformer. This enables the use of smaller die sized and higher RDSon FETs for the switches 720 and 725. In addition, ceramic capacitors can also be used, and the ratio of the transformer 740 drops from about 170:6 to 1:1. The ultimate result is the ability to design the circuit 135′ using surface mount devices (SMD) and the possibility to embed the windings 745 and 750 of the transformer 740 into a printed circuit board. Manufacturing is improved by removing the need for wave and/or manual soldering of components, and instead using reflow soldering.

A printed circuit board, including the components of the lamp driver 135′, is mounted in a plastic housing adapted to hold and maintain E-core magnets in a correct position with respect to the embedded transformer 740 coils, greatly simplifying manufacture.

Dimming of fluorescent lamps in prior art systems was accomplished by adjusting the frequency and the current to the lamp, while dimming of induction lamps is achieved by “bursting” a high-frequency output (e.g., 250 kHz). Bursting involves putting a high-frequency signal on a lower frequency pulse width modulated (PWM) signal. For example, a 25 to 40 kHz signal having a 50% duty cycle can have a 250 signal embedded in the “on” portion of the duty cycle. The duty cycle determines the amount of dimming (e.g., approximately 50% dimming with a 50% duty cycle). In some embodiments, the ballast 100 uses burst dimming to operate fluorescent lamps. Burst dimming reduces or eliminates the need to use the heater circuit 130 to heat the lamp during dimming.

The controller 115 also controls dimming of non-linear bulbs. For example, an analog dimmer switch provides a linear signal to indicate the amount of dimming requested and the controller 115 controls the power provided to the bulb in a non-linear manner to achieve a linear dimming of the light produced by the bulb. The linear dimming of the non-linear bulb can be accomplished using the light sensor 475 or by programming the controller 115 with the characteristics of the non-linear bulb.

In some embodiments, the controller 115 performs health, usage, and monitoring (HUMS) of the lamp, the ballast, and the power system. The controller 115 detects various parameters such as voltage, temperature, communication issues, etc. The controller 115 determines if errors have occurred such as under/over voltage, voltage dropout, over temperature, bulb failure, communication failure/intermittent failure, etc., and maintains a record in non-volatile memory of the controller 115. Diagnostics are communicated via the communication interface 125 to an external device. Alternatively or in addition diagnostic codes can be provided by a 7-segment display, an LCD, an LED, flashing of the bulb, etc.

The controller 115 also monitors usage: accumulating hours of operation, temperature levels, hours of operation at different temperature levels, number of on/off cycles, etc. The controller 115 also makes determinations based on monitored and accumulated information. For example, the controller 115 generates a current state of health, an estimated end of bulb life, etc. In some embodiments, the controller 115 provides the determinations to an external device via the communication interface 125. In addition, the controller 115 can modify operation based on the determinations. For example, if the estimated bulb life is less than a threshold or the temperature exceeds a threshold, the controller 115 may reduce power to the bulb to extend the life of the bulb.

In some embodiments, the controller 115 is provided with configurable parameters during commissioning of the ballast 100. For example, the controller 115 can be configured with parameters such as lamp type/size/quantity, type of light fixture, geographic location, room number, floor number, building number/address, a group allocation, installation date, ambient light thresholds, lighting schedules, etc. The controller 115 operates the lamp based on the provided parameters and can make adjustments to optimize operation of lamp (e.g., to improve bulb life).

The phosphor light output of fluorescent and induction lamps deteriorates in a known manner over the life of a lamp. In some embodiments, the controller 115, using HUMS data, increases power to the lamp to compensate for the deterioration.

Various features and advantages of the invention are set forth in the following claims.

What is claimed is:

1. A universal ballast, the ballast comprising:
a power converter configured to receive an input signal and convert the input signal to a direct current (DC) voltage having a first magnitude;
a transformer having a center-tapped primary winding coupled to the power converter and a secondary winding coupled to a lamp;
a current sensor configured to sense a current in the secondary winding; and
a controller configured to receive an indication of the detected current from the current sensor and to determine correct operating parameters for the lamp.

2. The universal ballast of claim 1, further comprising a plurality of switches controlled by the controller, the plurality of switches controlling an application of the input signal to the primary winding.

3. The universal ballast of claim 1, wherein the first magnitude is about 300 volts.

4. The universal ballast of claim 1, wherein the input signal is about 24 volts DC.

5. The universal ballast of claim 1, wherein the input signal is about 380 volts DC.

6. The universal ballast of claim 1, wherein the input signal is about 85 to about 305 alternating current (AC) volts.

7. The universal ballast of claim 1, wherein the primary winding and the secondary winding are embedded in a printed circuit board.

8. The universal ballast of claim 1, wherein the components of the ballast are surface mount devices (SMD).

9. The universal ballast of claim 8, wherein the SMD components are connected to a printed circuit board by reflow soldering.

10. The universal ballast of claim 1, wherein the controller determines that the lamp is one of a T5, T8, and compact fluorescent lamp adjusts the operating parameters of the ballast to match the lamp type.

11. The universal ballast of claim 1, further comprising a plastic housing.

12. The universal ballast of claim 1, further comprising at least one of a temperature sensor, an ambient light sensor, an audio sensor, and an input voltage sensor.

13. The universal ballast of claim 12, wherein the audio sensor provides detected audio signals to the controller, the controller reacting to verbal commands received by the audio sensor.

14. The universal ballast of claim 12, wherein the audio sensor provides detected audio signals to the controller, the controller determining when people are present in an area serviced by the lamp, and controlling the lamp based on the determination.

15. The universal ballast of claim 12, wherein the audio sensor provides detected audio signals to the controller, the controller controlling the lamp based on the audio signals detected.

16. A gas-discharge light fixture, the fixture comprising:
a gas-discharge lamp; and
a ballast including
a power converter configured to receive an input signal and convert the input signal to a direct current (DC) voltage having a first magnitude,
a transformer having a center-tapped primary winding coupled to the power converter and a secondary winding coupled to a lamp,
a current sensor configured to sense a current in the secondary winding, and
a controller configured to receive an indication of the detected current from the current sensor and to determine optimum operating conditions for the lamp.

17. The gas-discharge light fixture of claim 16, wherein the first magnitude is about 300 volts.

18. The gas-discharge light fixture of claim 16, wherein the primary winding and the secondary winding are embedded in a printed circuit board.

19. The gas-discharge light fixture of claim 16, wherein the components of the ballast are surface mount devices (SMD), and are connected to a printed circuit board by reflow soldering.

20. The gas-discharge light fixture of claim 16, wherein the controller determines that the lamp is one of a T5, T8, and compact fluorescent lamp adjusts the operating parameters of the ballast to match the lamp type.
